(19) United States
(12) Patent Application Publication
(10) Pub. No.: US 2004/0261016 A1
(43) Pub. Date: Dec. 23, 2004

(54) SYSTEM AND METHOD FOR ASSOCIATING STRUCTURED AND MANUALLY SELECTED ANNOTATIONS WITH ELECTRONIC DOCUMENT CONTENTS

(75) Inventors: Jeffrey Brian Glass, Castro Valley, CA (US); Elizabeth Derr, Richmond, CA (US)

Correspondence Address: Jeffrey B. Glass, 4492 Hillsborough Drive, Castro Valley, CA, 94546, US

(73) Assignee: MIAVIA, INC., Castro Valley, CA (US)

(21) Appl. No.: 10/710,084

(22) Filed: Jun. 17, 2004

Related U.S. Application Data
(60) Provisional application No. 60/481,003, filed on Jun. 20, 2003.

(51) Int. Cl. G06F 15/00

(52) U.S. Cl. 715/512

(57) ABSTRACT

A system and method is provided for assisting a human document annotator in recording semantic judgments about the contents of sample electronic documents. A system administrator first configures and stores a document annotation definition at a server computer, providing a precise and consistent structure for annotating documents and portions of documents. Documents intended to serve as sample documents for pattern matching against unknown documents are collected and stored at the server computer. A human annotator located at a client computer connected by a net-work to the server computer requests a display of a sample document to be annotated. A document is transmitted in an annotatable form from the server computer to the client computer. The human document annotator reviews the annotatable document, records semantic judgments about the document using interactive controls displayed with the document, and transmits a set of selected annotation values to the server computer. The server computer then stores the values and associates them with the document. The set of annotated documents, enhanced by the addition of structured semantic judgment information, then may be queried by other document management systems, improving the accuracy with which other systems perform automated document retrieval, comparison or filtering actions.

### BACKGROUND OF INVENTION

1. Field of the Invention

The annotation system relates to the field of classifying electronic documents and their contents to aid in their retrieval or comparison to other documents. Specifically, the annotation system relates to software applications that provide a method of assisting a human operator in viewing and recording judgments about the contents of electronic documents.

2. Prior Art

Electronic document management systems have evolved to include increasingly refined methods of document classification in order to support more effective use of documents. The need for more refined classification methods has grown as document collections have become larger over time and the range of document types and characteristics has expanded. Applications of document classification include document storage, retrieval, editing, evaluation, comparison and filtering. Document classification may refer to the indexing or annotation of entire documents and to portions of documents.

Some automated methods of document indexing or document annotation have been developed that are well suited to particular types of documents. Automated systems can speed completion of document classification tasks beyond the capabilities of manual document indexing or annotation. These automated systems are useful in cases where there are many documents and document types, as well as many document classification possibilities. Automated document indexing or annotation methods are also suitable in cases where misclassification of some documents does not cause a significant problem for document users.

Document comparison or filtering systems exist that attempt to automatically judge the classification of an un-known document by comparing its features to a collection of previously classified sample documents. Prior art automated document classification systems generally employ a document content pattern storage component, a method of extracting and processing the contents of new or unknown documents and a method of comparing patterns found within the extracted contents to the set of stored patterns. The result of the comparison is an assessment of similarity that is used to make an automated classification decision.

Drawbacks of Automated Document Classification Systems

The drawback of this approach is that some documents to be automatically classified may fall outside the experience represented by the set of stored document patterns, leading to errors. For example, a document containing content written in two separate languages may not be properly processed by a system trained to handle content only in one language.

Another example illustrating the difficulties of interpreting and automatically classifying documents is the problem of deliberately disguised documents. In such cases document copies contain dynamically varied content inserted by their authors in order to subvert automated detection and classification of document copies. Junk email messages often exemplify this problem, which becomes apparent when a representative document, such as a junk email message, is collected from a network environment, such as an email system. The sample junk email message may be obscured by obfuscating content, hindering the effectiveness of the message as a pattern against which to evaluate other messages. An obfuscated junk email message may be similar, in some sense, to many other messages within a network. The features of an obfuscated sample junk email message will usually include both recurring content and at least some irrelevant content that differs from one version of the message to another. This irrelevant and dynamic content is inserted to confuse automated document copy detection systems.

Another drawback of automated document classification systems is that the content of some documents may consist of data patterns that are inconsistent with the patterns programmed into and expected by automated systems, leading to further errors. For example, a text pattern detection processor may fail when presented with text that is rendered in the form of a pointer to a graphic image file, rather than using individual character symbols.

Similarly, when language of a certain type is expected by a document processor, and no language is presented, the unanticipated result is a failure of document interpretation.

Prior Art Automated Document Classification Systems

The following examples illustrate relevant prior art in the field of automated document classification systems.

U.S. Pat. No. 5,251,131 issued to Masand describes a set of document classification rules derived from a document training set. Probability weighting is used to classify natural language. The drawback of applying natural language interpretation to some types of documents, such as email documents, is that email documents awaiting classification may contain content that is completely unfamiliar to a natural language processor. For example, junk email messages often include text rendered as graphic images, by referencing a graphic image file to be displayed within an HTML document. This tactic can successfully evade text-based content filtering systems. Another frequent tactic, including nonsense text, also can fool automated detection based on a document training set that anticipates normal language patterns. The present invention does not employ a training set or automated natural language processing to classify or interpret documents.

In U.S. Pat. No. 6,263,121 issued to Melen, et al a method is disclosed for archiving and retrieving similar documents. This method indexes documents to assist in their retrieval by automatically locating document attributes contained within documents and comparing them to a predetermined set of document attributes. Depending on the level of similarity between document attributes in the predetermined set and the attributes extracted from an unindexed document, a classification may be made entirely via automated processing. The present invention does not require automated comparisons to documents contained within a training set to judge how documents should be indexed. Similarly, in U.S. Pat. No. 6,094,653 Li, et al a method is disclosed for automatically classifying documents using probabilistic comparisons of word clusters found in unclassified documents and classified documents. The present invention does not employ automated comparison of document word clusters to classify documents.

In U.S. Pat. No. 6,453,307 issued to Schapire, et al a method is disclosed for performing automated multi-class, mutli-label information categorization using weighted information samples and a base hypothesis to predict which labels are associated with a given information sample. The present invention does not employ weighted information samples or a base hypothesis relating information sample weights to information samples.

In U.S. Pat. No. 6,363,174 issued to Lu an automated method is disclosed for content identification and categorization of textual data using the Burrows-Wheeler transform in conjunction with mapping techniques and statistical comparison. The present invention does not employ a mathematical or statistical model to categorize content, documents or data.

In U.S. Pat. No. 6,553,365 issued to Summerlin, et al a semi-automated system is disclosed for the classification of electronic documents that are candidates to become an official record. The system employs a training set of documents classified by human operators to establish a probabilistic relationship between each classification instance and the contents of a document. The system then automatically defines a boundary between cases permitting automated classification and cases requiring the intelligence of human understanding of the meaning or context of the candidate electronic record. In such a system, some types of documents will cause classification errors to result because document content may present itself which is of a type outside the experience of the document training set and pattern recognition programming. The present invention does not involve automated classification of document contents and instead relies entirely on human judgment to make content classification distinctions.

In U.S. Pat. No. 6,044,375 issued to Shmueli, et al a method is disclosed in which document metadata is extracted using a neural network and a list of common uses of a set of words. Some types of documents will cause classification errors to result using such a method, again because content may present itself which is of a type outside the experience of the automated programming. The present invention does not inln U.S. Pat. No. 6,363,174 issued to Lu an automated method is disclosed for content identification and categorization of textual data using the Burrows-Wheeler transform in conjunction with mapping techniques and statistical comparison. The present invention does not employ a mathematical or statistical model to categorize content, documents or data.volve automated classification of document contents via a neural network and a list of common uses of a set of words.

Appropriate applications of manual document classification

The advantages of manual document classification and annotation compared to automated methods are more apparent in some types of applications than others. Document applications in which manual document indexing is superior include applications where document content is difficult to classify with accuracy using automated methods, where highly negative consequences can result from classification errors, and where the number and complexity of documents and document classification types is small enough to be manageable by human classifiers.

Some documents to be classified may be representative samples of a large population of similar documents. In some cases an entire set of similar documents contain significant amounts of personalizing content or obfuscating content, which may be inserted to fool automated classification systems such as email filtering systems. The above-mentioned limitations of automated document classification systems point to a need for a means to incorporate the higher intelligence of human reasoning into some document classification processes. Specifically, it would be advantageous in such cases to provide an efficient mechanism by which human judgments about sample document contents could be captured to accurately distinguish between relevant document content and irrelevant document content. Subsequent to this human assistance, accurately classified and indexed sample document content then could be used to improve the accuracy of automated analysis of unknown documents.

Examples of document types that may feature these types of classification hindrances include dynamically generated Web pages that feature obfuscating metatag information or body content, partially plagiarized text documents, keyword-laden resumes, and advertising documents such as bulk or junk email messages. An example is presented below illustrating the phenomenon of two similar advertising email messages which have be automatically crafted by their sender to fool content-based automated email filtering systems that look for telltale signs of unwanted messages.

Example of Two Similar Email Message Documents

| Sample advertising | | Sample advertising |
|---|---|---|
| email #1 | Comment | email #2 |
| The rain in Spain stays mainly | Variable text | A stitch in time saves nine. |
| on the plain. | | |
| Trust us for the lowest prices | Recurring Text | Trust us for the lowest prices |
| available for prescription medi- | | available for prescription medi- |
| cation. | | cation. |
| No waiting rooms for Phenterm- | Recurring Text | No waiting rooms for Phenterm- |
| inee Prozacc Prozac. | | inee Prozacc Prozac. |
| http://www.rxcabinet.biz | Recurring Text | http://www.rxcabinet.biz |
| Click here to be removed | Recurring Text | Click here to be removed |
| http://www.rxcabinet.biz/remove.php | Recurring Text | http://www.rxcabinet.biz/remove.php |
| 58yd9829hd088h8asdoih98487d | Variable text | 9dfgj4398fihadihfig98inlafgkj |

In some cases such as the one illustrated above it may be possible to automatically detect and suppress or remove personalizing or obfuscating content. Recent experience demonstrates that some document authors will go to considerable lengths to disguise the contents of their documents by using increasingly subtle obfuscation patterns. Regardless of the difficulties, if obfuscating content contained within sample documents is not removed or suppressed then the usefulness of sample documents as pattern recognition tools becomes degraded. The increasingly cunning disguising of document content by document authors requires human intervention to interpret these patterns in samples of newly created or revised documents. A record of these interpretations would enable subsequent document management systems to take appropriate actions when obfuscated documents are encountered.

In the example illustrated above, it is relatively easy for a trained human document classifier to quickly determine which parts of each of the above referenced document samples are relevant to their author's advertising purpose and which portions of these documents may be considered irrelevant padding. Human reasoning can solve this pattern recognition problem easily even if the document content is reformatted in clever ways such as altering the location or appearance of various text elements or by rendering text in the form of graphic images. Further, if only one of the two documents were available as sample documents for analysis, in most cases a human reviewer can still discern the semantic meaning of the document and the text segments composing the document and can correctly classify the document and its components with little difficulty. In contrast, automated systems frequently have great difficulty discriminating between nonsense text and semantically significant language. The more subtle the obfuscation technique, the more difficult it is for automated systems to make an accurate classification determination.

For example, a clever bulk email sender might resort to copying segments of irrelevant text from an unrelated document such as an encyclopedia or Web page and inserting variable passages from this material into an advertising message in order to disguise the presence of advertising content. Similarly, a resume author might produce various versions of a resume that contains a varied array of keywords selected to enhance, via exaggeration, the probability of having a resume reach a decision maker by passing through automated resume filtering systems without detection of inappropriate keywords.

Prior art document classification methods involving automation and manual input

Prior art methods exist that teach automatic methods of capturing and storing manually entered comments or annotations associated with electronic documents. However no satisfactory prior art method is found for manually classifying, indexing or annotating electronic documents using a tightly structured annotation format applied to documents as a whole and optionally applied to predefined document segments that are consistently derived for any type of document. The following examples illustrate relevant prior art in the field of document classification systems that use automation to support a partially manual document classification, indexing or annotation process.

U.S. Pat. No. 6,243,722 issued to Day, et al teaches a method for collaboratively editing documents, including a method for associating user comments with particular portions of a shared document. In this method a document is displayed in a manner indicating portions which may be commented upon by users and other portions which may not commented upon by users. The present invention does not provide for collaborative annotation of document contents. The present invention does not require that documents be partitioned into areas for which comments may or may not be made. Day teaches a method for a graphic user interface, described as a pop-up window, by which users may enter comments. The present invention does not require a pop-up window feature to format and present document annotation input controls.

U.S. Pat. No. 6,551,357 issued to Madduri presents a method, system, and program for storing and retrieving markings for display to an electronic media file. The objective of this method is to provide a means of capturing document annotations and subsequently displaying these annotations in a color coded manner superimposed on a display of an electronic document or media file. The present invention does not provide a method for color coding or displaying document annotations superimposed on displays of annotated documents or media files.

In U.S. Pat. No. 5,146,552 issued to Cassorla, et al a method is disclosed for associating annotation with electronically published material, such as an electronic book. This method specifies that a user manually enters an annotation, which is then electronically stored and associated with a user-selected portion of the material. The method does not provide for the entry and storage of annotations related to a document as a whole rather than related to a specific portion of a document, which is a desirable feature when classifying documents. Additionally, Cassorla's method specifies that manually entered annotation content is to be displayed on demand proximate to a display location for a selected and designated portion of a document. The present invention has the objective of supporting document classification and similarity comparison objectives. These objectives do not require visual display of annotation information but instead are used in document queries. Therefore the present invention does not require a mechanism to display previously entered annotations in a user display of a document in the manner described by Cassorla et al.

U.S. Pat. No. 6,460,050 issued to Pace, et al proposes a method of filtering junk email messages using digital content identifiers, or mathematical digests of email documents, to support automated comparisons of manually nominated messages which some users have classified as junk messages, and unknown messages received by others users. This method combines document classification and document filtering procedures. The present invention does not include document filtering. The present invention also does not require that end users employ a file content ID generator creating file content IDs using a mathematical algorithm in order to identify files nominated by end users as junk messages.

U.S. Pat. No. 6,453,327 issued to Nielsen discloses a method for identifying and discarding junk electronic mail. This method provides the capability for a group of trusted users to collectively determine whether a given electronic mail message is junk e-mail. Further, if the given electronic mail message is determined to be junk mail, the e-mail systems of other trusted users in the group dispose of unviewed copies of the junk e-mail. Thus, the invention is intended to reduce the exposure of junk e-mail messages to the group of trusted users.

As a means of determining which messages should be classified as junk e-mail, Nielsen's patent teaches a method for collecting user opinions about whether email messages received by trusted users are junk and uses that information as a filtering criterion. This method, while useful in that it employs the higher reasoning powers of human intelligence to distinguish between potentially subtle differences between junk email and non-junk email messages, is devised in a way that makes its implementation awkward. First, the method delegates message classification to end users of an email system, rather than presenting a system suitable for use by a system administrator or service provider, which would spare email document recipients from the burden of classifying documents they collectively may wish to avoid. The present invention is designed so that it may be used by a service provider operating with as few as one manual document reviewer and therefore can be operated in a way that does not burden end users with document classification responsibilities and does not incur a delay in classification caused by the preoccupation of end users with other tasks.

Second, Nielsen's method includes both document classification and filtering functions, whereas the present invention does not encompass document filtering functions but instead provides document pattern output suitable for use by document classification or similarity detection functions, including email filtering functions.

Third, the method includes an email system for distributing documents for review and the results of document evaluations. The present invention does not employ the use of an email system for these functions.

Fourth, the method requires a database, authentication keys and special purpose client software in order to implement the method where end users are connected to the system. The present invention does not require end users responsible for classifying documents to have a database, authentication keys and special purpose client software.

U.S. Pat. No. 6,421,709 issued to McCormick, et al discloses a similar collaborative email filtering method whereby email users can review and judge quarantined email messages as junk. Subsequent to classification, information about end user reviews, including specific character strings included in email messages, can be used for collaborative filtering of similar messages among a group of users.

While McCormick's method offers a way to capture manual classification judgments about documents and also about portions of documents, the McCormick method has significant drawbacks. This method depends upon receiving samples of junk messages from end users as a way to establish reference messages against which to compare unknown messages. The present invention does not require that pattern or reference documents be collected from end users. End users may be preoccupied, forgetful, slow to respond, or otherwise resistant to collaborating in an effective junk message reporting scheme. Second, the method requires counting the number of documents received by a central collection point that are deemed by users to be junk and that also appear similar to each other.

Further, McCormick teaches that the current count value for a group of apparently similar documents nominated by end users as junk messages is compared to a predetermined count threshold value to determine whether a representative message considered by some users to be junk should be confirmed for collective use as a filtering pattern document. The present invention does not require that a document be encountered more than once to enable a classification decision, reducing potential delays in classification.

U.S. Pat. No. 6,546,405 issued to Gupta, et al discloses a method for manually annotating temporally dimensioned multimedia content. The present invention is not intended for annotation of temporally dimensioned data and therefore does not include a method for capturing and linking annotation data according to a relative time index specifying a time-indexed position within a temporarily dimensioned document.

In U.S. Pat. No. 6,014,677 issued to Hayashi , et al a method is disclosed for managing documents by utilizing additive information provided by a user via a graphical user interface. Users provide evaluations by selecting an evaluation format that specifies the structure of evaluation data. The present invention does not require providing a means for users to select an annotation format. To the contrary, the present invention teaches that annotation formats should be predetermined by a system administrator or service provider in order to ensure that annotation data is consistently formatted and structured for each document or document portion and therefore can support meaningful cross-document annotation value queries.

Hayashi's method requires providing a document selecting device allowing a user to select one document data, or document portion, and a format selecting device allowing for selection of a desired evaluation format. The present invention teaches, to the contrary, that cross-document comparison capability is enhanced by pre-selecting the boundaries of specific document portions and document evaluation formats rather than leaving these choices at the discretion of document evaluators. The objectives of the present invention are to facilitate document identification and comparison, which cannot be effectively accomplished if the annotation method is too unstructured to enable logical database queries of annotation data.

Hayashi's method also requires simultaneously displaying comment tags with selected document data when selected document data is subsequently displayed on the user interface. The present invention is not intended for displaying annotations subsequent to their capture and therefore does not require a means of displaying annotations alongside or within annotated documents.

In U.S. Pat. No. 5,983,246 issued to Takano a method is disclosed for classifying documents through a combination of manual and automated means. Takano teaches that a service provider manually classifies some of the documents distributed and existent in a network environment while any other document is automatically classified by calculating a conformity of these documents with the classified document group. Unlike the method described by Takano, the present invention does not require that documents are manually classified in each possible classification item, nor does it require that a certain number of documents be manually classified in each classification item in order to improve the accuracy of the classification system.

Takano further teaches that manual document classification of some documents or all but one document in a document classification may be assigned to document creators to take advantage of superior knowledge of the contents of documents they have created. The assumption behind this feature is that document authors may be trusted to use their own knowledge of their documents to classify their documents with greater accuracy than if classifications were performed by others, such as service provider. The drawback of this approach is that in some cases authors may deliberately misclassify documents they have authored in order to hinder classification by automated document analysis systems, such as plagiarism detection systems, resume classification systems, Web page indexing systems or junk email filtering systems. The present invention does not feature a method by which document creators may annotate or classify their own documents, thereby avoiding the drawback of biased document classification.

Takano teaches that manual classification judgments are based on analyzing the contents of several typical documents. The present invention does not impose this requirement.

Takano teaches that unclassified documents are collected and stored in a database and subsequently classified. The drawback of this approach is that whenever the volume of unclassified documents received is large then the timely performance of the automatic classification system may be hindered by having to locate and read the contents of documents held in database storage. The present invention does not employ this approach and instead optimizes performance by classifying newly received documents while they exist in the more readily readable form of temporary random access memory.

Takano teaches that unclassified documents may be automatically classified by comparing them to previously classified documents on the basis of keyword frequency distributions. The drawback of this approach becomes evident when attempting to classify documents that have been authored with a deliberate intention to evade classification through insertion of personalization or obfuscation text. The present invention does not include an automated method of making semantic classification distinctions.

U.S. Pat. No. 6,519,603 issued to Bays, et al presents a method of managing information which combines features for organizing an annotation structure and inputting manual annotations as well as generating and responding to structured queries to retrieve documents that satisfy queries about document content or document annotation content. The present invention does not require querying and query response features.

Further, Bays teaches that the annotation structure should include selecting an annotatable data item to be annotated by selecting an attribute of an entity, where the entity is referenced by any one or more of: an index, a schema object, or a set of the attribute or schema object. The present invention does not require selecting annotatable data items using formal attributes of an entity that form natural or expected document elements as taught by Bays. While it is convenient to employ the inherent structure of a document to isolate its individually annotatable items, some documents may feature content that can foil attempts to correctly identify natural boundaries between useful document text groupings. Such content may include personalization or obfuscation text. In such cases a document author wishes to subvert a document indexing process by inserting text designed to disguise the document content and structure. A common tactic employed by such authors is to use unnatural and unexpected document content or content boundaries, such as superfluous punctuation and formatting characters, text encoding and highly granular padding of significant text with insignificant text. These techniques can confuse a system that uses the expected structure of a document to define document elements that should be individually annotatable. Therefore it would be desirable to avoid trusting the inherent structure of such documents to indicate boundaries separating annotatable content and instead to impose an independent set of rules for parsing document content into annotatable text groupings that is less susceptible to obfuscation techniques.

From the foregoing review of prior art one may conclude that existing methods of automatic, semi-automatic and manual methods of annotating electronic documents are not well suited to the task of capturing manually entered structured semantic judgments about documents so that annotated documents may serve as accurate pattern base documents without encountering the drawbacks of the above-mentioned systems.

### OBJECTS AND ADVANTAGES OF THE INVENTION

It is therefore an object of this invention to provide a system for efficiently capturing human judgments about the semantic content of documents and storing these judgments in a structured form which enables use of annotated sample documents for subsequent identification or classification of other documents.

It is a second object of this invention to provide a system and structure for annotating documents each as a whole entity.

It is a third object of this invention to provide a system for annotating consistently pre-selected portions of documents following a predetermined set of rules for defining boundaries between document portions, having the effect that partial document matching systems using this information can defeat attempts by document authors to subvert document matching systems.

It is a fourth object of this invention to provide a system for capturing annotations provided by human document reviewers in a structured and consistent way so that the data derived from an annotation process may be usefully subjected to database queries that rely upon structured data and data formats.

It is a fifth object of this invention to provide a system for annotating electronic documents which, through reliance on human intelligence to make subtle semantic distinctions, can capture accurate content annotations across a diverse array of content types, such as text documents, html documents and documents that employ obfuscation techniques to evade automated document similarity detection systems.

It is a sixth object of this invention to provide a system for annotating electronic documents that does not require collaboration among two or more end users to perform document annotation services for others but instead can operate with as few as one document annotator operating in the mode of a service provider.

It is a seventh object of this invention to provide a system for annotating electronic documents that does not require multiple occurrences or sightings by the system or by document annotators of the same or substantially similar document to enable a classification decision.

It is an eighth object of this invention to provide a system for annotating electronic documents that minimizes or eliminates redundant document annotation activity by recognizing and discarding document samples submitted for annotation that exactly or closely match previously annotated documents.

It is a ninth object of this invention to provide a means of supplying additive information about a set of sample or reference documents so that a separate document search, comparison or filtering system may use this additive information to operate more accurately than without the aid of the additive information.

### SUMMARY OF INVENTION

The annotation system of the present invention overcomes the problems of the prior art by utilizing a system and method for assisting a human operator or annotator in annotating sample documents. The annotation system provides a novel and beneficial way of viewing each of a set of sample documents, recording structured data representing semantic judgments about the contents of each document and storing the semantic judgment information. This annotation data and the document information to which the annotation data relates can be made accessible to document management systems that find, compare or filter unknown documents based on their similarity to sample documents. By using the data provided by the annotation system, these separate document management systems can perform their functions with greater accuracy than without the aid of the sample annotated document information.

Storage means are provided for documents, document metadata and document annotation definitions on a server computer. A system administrator or service provider configures and stores at least one document annotation definition at the server computer. A document annotation definition, once configured and stored, provides a structure for the method by which documents are annotated.

Documents intended to serve as sample documents for pattern matching against unknown documents are collected and stored at the server computer. If desired these documents may be subjected to a duplicate removal process upon arrival or after storage.

A human annotator located at a client computer connected by a network to the server computer requests a display of a document to be reviewed and a document is transmitted in an annotatable form from the server computer to the client computer. The human annotator reviews the annotatable document, records semantic judgments about the document using interactive controls displayed with the document, and transmits a set of selected annotation values to the server computer. The server computer then stores the selected annotation values and other metadata and associates the additive information with the document.

Annotated document information is structured in such a way that, if published to other document management systems, it enables fine-grained and semantically accurate classification of the contents of unknown documents. These classifications can be inferred by comparing the contents of unknown documents to the contents of annotated sample documents and calculating a similarity measure between unknown documents and documents that have been annotated.

### BRIEF DESCRIPTION OF DRAWINGS

FIG. 1 illustrates features of two computers, linked together in a network, in which the present invention may be embodied;

FIG. 2 illustrates a portion of a computer designated as a server computer, including database storage capabilities and application software units that represent components of the present invention;

FIG. 2A illustrates the presence on a client computer of a program capable of displaying annotatable documents and accepting annotation value selections and annotation session control commands;

FIG. 3 is an overview of the operation of the invention in accordance with a preferred embodiment, omitting from the illustration, however, the step of configuring an annotation definition;

FIG. 4 illustrates a data structure representing a document annotation definition in accordance with a preferred embodiment;

FIG. 5 illustrates the process used to collect new documents, parse them into document text substrings and store them in a database;

FIG. 6 illustrates a set of document text substring boundary definitions that may be used to define the boundaries for and identify document text substrings within a document;

FIG. 7 illustrates the process by which documents are retrieved from the database upon request, formed into an annotatable document and transmitted to a client computer workstation where a request for a document has originated;

FIG. 8 illustrates the structure of an annotatable document in accordance with a preferred embodiment;

FIG. 9 illustrates the process of capturing selected annotation values at a client computer workstation;

FIG. 10 illustrates a graphical user interface display presented by an application program receiving instructions to display an annotatable document in parsed form;

FIG. 11 illustrates a graphical user interface display presented by an application program receiving instructions to display a document in full text form;

FIG. 12 illustrates a graphical user interface display presented by an application program responsive to receiving instructions to display a document in source code form;

FIG. 13 illustrates a graphical user interface display presented by an application program responsive to receiving instructions to display an annotator login screen and controls;

FIG. 14 illustrates a graphical user interface display presented by an application program responsive to receiving instructions to display controls for resuming a paused annotation session or logging out to terminate an annotation session;

FIG. 15 illustrates the structure of an annotation value packet in accordance with a preferred embodiment;

FIG. 16 illustrates the process of receiving and storing a selected annotation value packet at the server computer;

FIG. 17 illustrates a detailed view of the process of receiving and storing a selected annotation value packet at the server computer;

FIG. 18 illustrates the process by which one or more unannotated documents thought to be duplicates of other documents may be searched and identified based on the presence of specified document features.

### DETAILED DESCRIPTION

Overview

The document annotation system comprising the present invention allows a service provider or system administrator to manage a document annotation process, or a method by which manually entered additive information may be associated with each electronic document in a set of electronic documents. These electronic documents exist in the computer memory of a server computer and function as patterns or reference documents that may be used by a separate document management system. Prior to performing document annotation tasks, each of the set of electronic documents is collected, parsed, and stored.

In a preferred embodiment of the invention, a client computer workstation functions as a user interface device, including a display device and at least one input device. Using this client computer workstation, a human operator requests and receives at the client computer workstation an annotatable document transmitted from the server computer. A display of at least one document is provided on the client computer workstation display device as well as interactive controls supporting the selection and capture of at least one value from among a predefined set of predefined selectable annotation values. The human operator then performs document annotation tasks, including selecting and inputting annotation values. After the annotation values are captured by the client computer workstation they are transmitted to the server computer, where the document record is then updated to reflect the results of the annotation data input.

The collection and storage of additive, structured annotation information enables useful queries to be performed by document search, comparison or filtering systems. In particular the annotation system of the present invention solves a significant problem encountered by some document management systems, namely that the features of some unknown documents to be classified may be obfuscated by their authors, who sometimes wish to avoid the accurate classification of their works. Junk email messages often exemplify this problem. The present invention solves this problem by enabling the efficient capture of human semantic judgments about sample documents. These judgments, according to a preferred embodiment of the invention, can be associated with a document as a whole and with particular parts of documents.

For example, a human annotator may indicate the topic or other classification of a sample document. In another example, an annotator may semantically label parts of a sample document that represent variable content that may have been inserted by the author to reduce the apparent similarity of the sample document to other versions of the document. By so labeling a sample document and sample document parts, a separate document management system designed to detect similar documents can use the additive information provided through the use of the present invention to ignore obfuscating content when comparing unknown documents to annotated sample documents, thereby improving document recognition ability.

Operating Environment

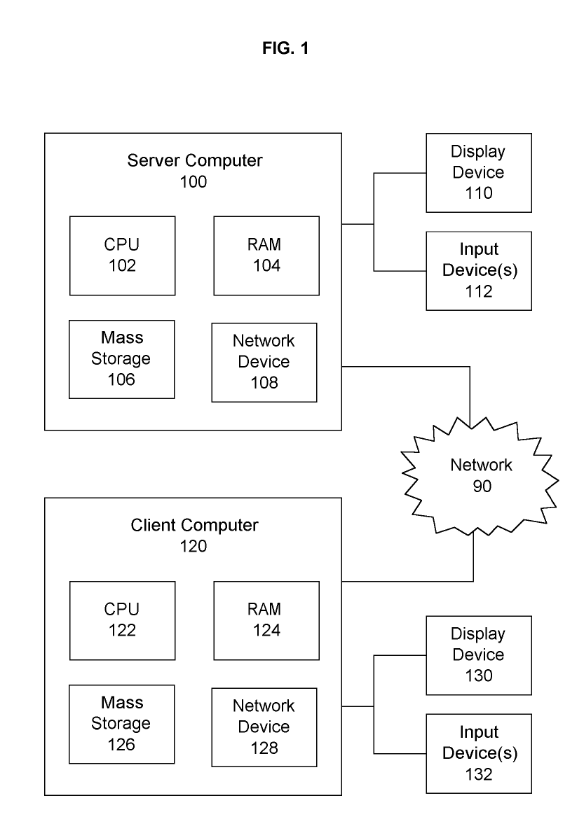

Some of the elements of a computer system configured to support the operation of the invention are shown in FIG. 1 wherein a server computer 100 is shown, having a CPU section 102, a random access memory section (RAM) 104, a mass storage section 106 typically taking the form of a disk drive storage device, and a network device 108 providing a method of connecting the server computer to other computers via a network 90. The server computer 100 has connected to it a display device 110 and at least one input device 112 such as a keyboard, a mouse or other user input device.

FIG. 1 also shows a client computer 120 connected via the network 90 to the server computer 100, with the client computer 120 also having a CPU 122, a random access memory section (RAM) 124, a mass storage section 126 typically taking the form of a disk drive storage device, and a network device 128 providing a method of connecting the client computer 120 to other computers via a network 90. The client computer 120 has connected to it a display device 130 and at least one input device 132 such as a keyboard, a mouse or other user input device.

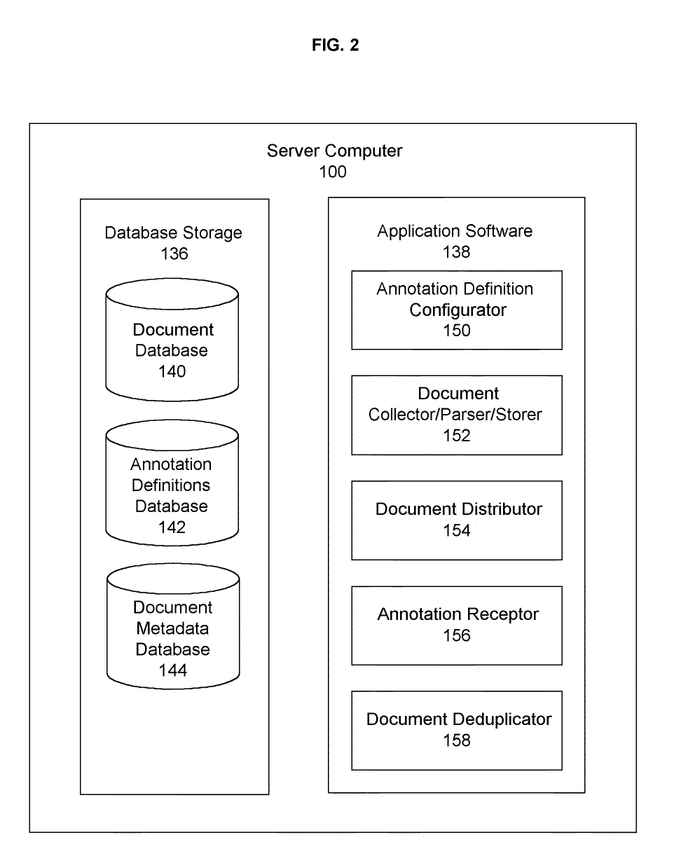

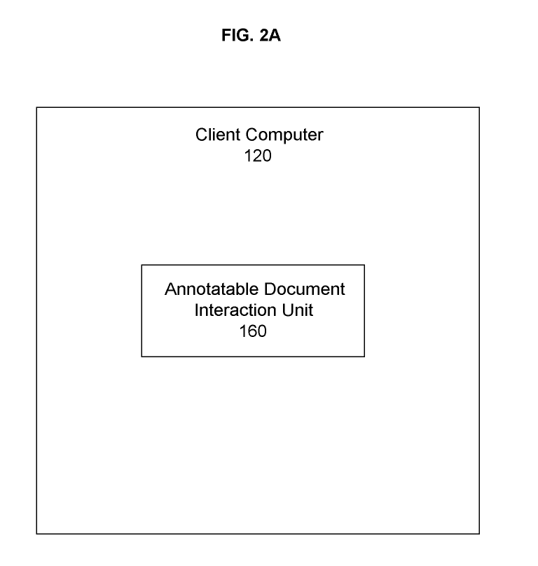

FIG. 2 illustrates a conceptual overview of the database storage 136 and application software 138 residing on the server computer 100. The database storage 136 includes a document database 140, an annotation definition database 142 and document metadata database 144. In a preferred embodiment these storage facilities take the form of a single relational database of a type that is well known among those skilled in the art. Several components of the application software 138 forming a part of the annotation system are illustrated in FIG. 2, including an annotation definition configurator unit 150 that allows an administrator to set up a data structure for document annotation procedures. A document collector/parser/storer unit 152 manages the process of registering and storing newly received documents and their components. A document distributor unit 154 is shown, and serves the purpose of transmitting annotatable documents upon request to the client computer 120 of FIG. 1. An annotation receptor 156 receives information from the client computer 120 when annotation values have been selected and transmitted from the client computer 120 back to the server computer 100. A document deduplicator unit 158 accepts requests to delete documents containing specific characteristics from the document database 140 and deletes one or more documents to prevent redundant annotation steps.

FIG. 2A illustrates the client computer 120 as including an annotatable document interaction unit 160, which may take the form of a graphical user interface (GUI) software application of a widely known type, such as a Web browser application. The annotatable document interaction unit 160 is installed on the client computer 120 and enables display of annotatable documents, capture of annotation inputs and acceptance and transmission of requests to the server computer to control an annotation session.

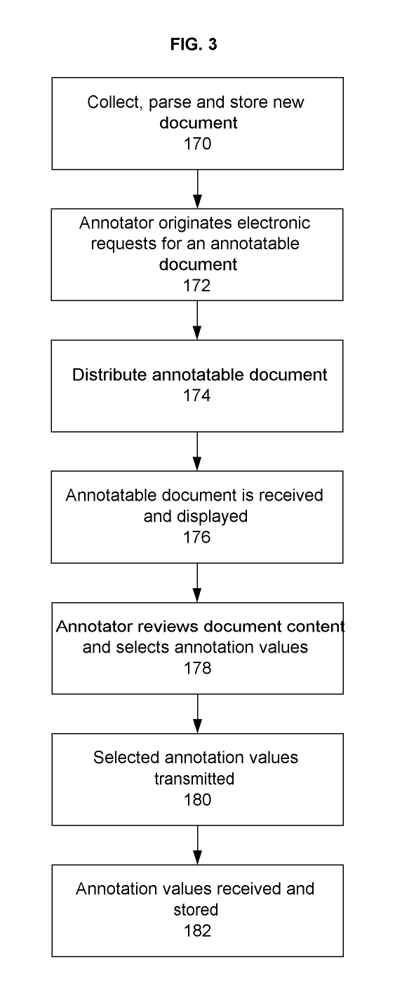

FIG. 3 illustrates a conceptual overview of the annotation process of the annotation system. Assuming that a document annotation definition exists as described below, each of a series or collection of documents intended to serve as sample documents to be annotated are collected, parsed and stored as step 170. In step 172 a human annotator originates an electronic request for an annotatable document. Responsive to such request, in step 174 of FIG. 3 an annotatable document is distributed from the server computer 100 of FIG. 1 to the client computer 120 of FIG. 1. In step 176 of FIG. 3 the annotatable document is received and displayed at the client computer 120 of FIG. 1. In step 178 of FIG. 3 the human annotator reviews the annotatable document and selects annotation values to associate with the document and, optionally, selects values to associate with portions of the document. In step 180 the selected annotation values are transmitted to the server computer 100 of FIG. 1. In step 182 of FIG. 3 the annotation values are received and stored at the server computer 100 of FIG. 1.

Before the annotation process may begin it is necessary for an administrator to configure a document annotation definition that controls the annotation structure for a set or class of documents to be annotated. One or more document annotation definitions may be configured and stored on the server computer 100 of FIG. 2 using the annotation definition configurator unit 150 of FIG. 2.

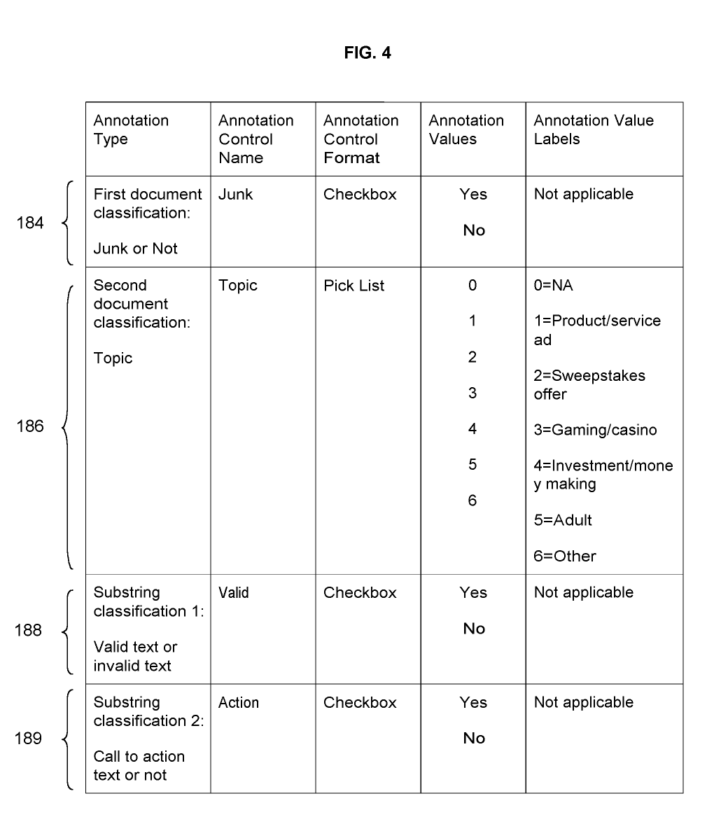

FIG. 4 illustrates an example of a document annotation definition for annotating email messages. In general, document annotation definitions, as illustrated by the example shown in FIG. 4, may be configured in any way and in any number or combination necessary to support a desired document annotation objective. As illustrated in FIG. 4, it is preferable to use input controls that impose constraints on the values a human annotator may select when annotating sample documents to ensure that the annotation data is rigorously structured and therefore capable of supporting logical queries originated by other document management systems. These constraints may be imposed by employing standard user interface form controls such as radio button controls, checkbox controls, pick list controls and other user interface conventions that are well known to those skilled in the art.

The column headings of the table in FIG. 4 illustrate the types of information comprising a document annotation definition. For each type of annotation to be applied to a document, the following types of information must be specified by the system administrator:

a) annotation type

b) annotation control name

c) annotation control format

d) annotion values

e) annotation value labels (if needed for the selected annotation control type)

As an example, in FIG. 4 a set of email message documents can be classified, in a first document annotation type 184, as either junk or not junk, in a second annotation type 186 as having a selected topic, and in third and fourth annotation types 188 and 189 as having one or more document text substrings that may be annotated according as to whether the substrings are valid or not and whether the substring text represents call to action text.

The sample document annotation definition of FIG. 4 illustrates how a system administrator may define the required additional attributes for each of the four illustrated document annotation types. The first document annotation type 184 features an annotation control name of Junk, an annotation control format of the checkbox type, and annotation values of yes and no. The checkbox control does not require annotation value labels since the checked or unchecked state of the checkbox control visually communicates to the end user the values of yes and no. The second document annotation type 186 features an annotation control name of Topic, an annotation control format of the picklist type, annotation values of 0, 1, 2, 3, 4, 5, and 6, and a set of annotation value labels associated with each annotation value. The pick list value labels exist to assist a human annotator in understanding the numeric values that represent data values that, when selected, become stored values in the document metadata database 144 of FIG. 2.

FIG. 4 further illustrates how an administrator may optionally include in an annotation definition one or more annotation types associated with substrings of text that are derived during step 178 shown in FIG. 3, in which documents are collected, parsed and stored. For example, FIG. 4 includes a line item for Substring classification 1: valid text or invalid text 188. As illustrated in FIG. 4, the format chosen by the administrator for displaying this annotation type in the annotatable document interaction unit 160 of FIG. 2A is a checkbox control with a name of Valid. The possible values for this annotation type are illustrated, for example, as the selectable values of yes and no and the labels associated with these two values are implied by the checked and unchecked states of a checkbox form control. Including this annotation type for each document substring enables capture of annotation information about each document substring of a document. As this example illustrates, the substring-level annotations can include whether a substring is considered by the annotator to include personalizing or obfuscating content.

In another substring annotation definition example, FIG. 4 illustrates that, optionally, a second substring classification annotation type may be defined, such as a Substring classification 2: call to action text 189. This type of document substring, if found within a sample document and correctly annotated, enables the annotation system to record the existence within a document of specific types of content, such as URLs, email addresses, phone numbers, postal addresses or other text substrings that signify a method of contacting the document author or an entity attempting to identify themselves in a document. Correctly annotating such substrings is useful if it can help identify similar documents that feature few common elements other than call to action text but also feature obfuscating text.

The method by which an administrator creates or edits a document annotation definition may take a variety of well-known forms, including coding each document annotation definition with all their features directly into the annotation definition configurator 150 of FIG. 2. Alternatively, it would be possible to provide a command-line or graphical user interface to the annotation definition configurator 150 of FIG. 2 for adding, editing or deleting a document annotation definition. It is also possible, using the method just described, to configure more than one document annotation definition so that the same document annotation system may be used to annotate different document types or classes according to different document annotation definitions.

Operation of the Annotation System

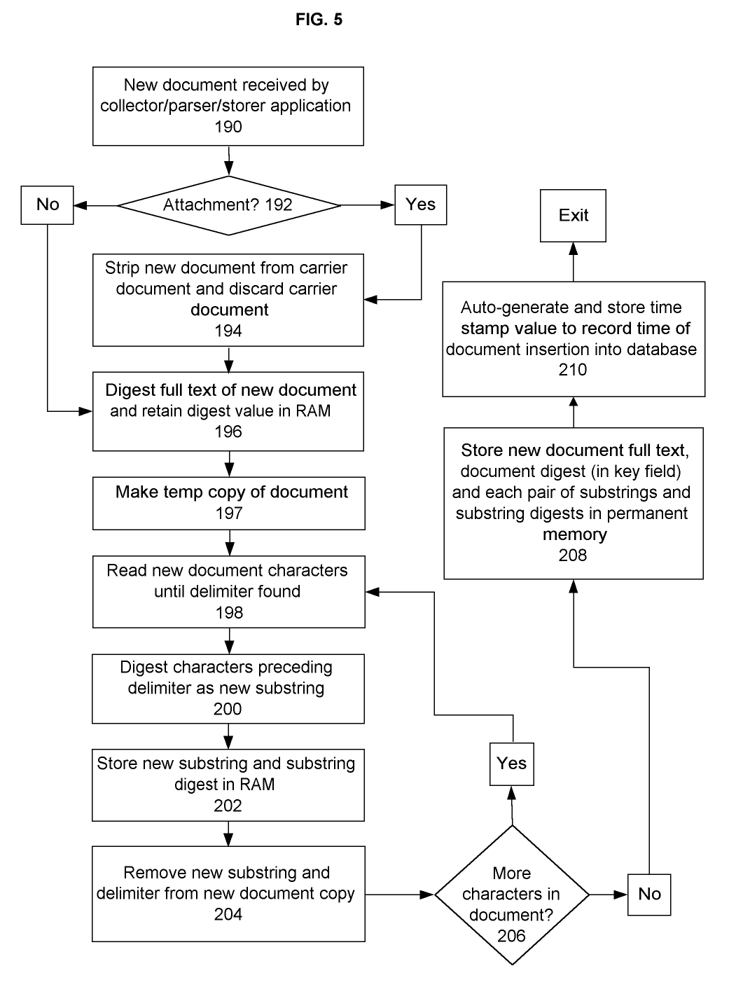

This document now will explain the detailed operation of the invention, beginning with a reference to FIG. 5, which illustrates the process of collecting, parsing and storing documents to be annotated. In step 190, each document submitted to the annotation system first is received by the document collector/parser/storer 152 of the server computer 100 of FIG. 2. In a preferred embodiment, wherein the sample documents collected by the system are email documents, an email server application program commonly known among those skilled in the art may be used as a component of the document collector/parser/storer to implement step 190 of FIG. 5, although other ways of receiving documents may be substituted. After a document is received, in a preferred embodiment each document is checked in step 192 of FIG. 5 to determine whether it is attached to a carrier document, such as an email message to which the document of interest may be attached. In an alternative embodiment a document or series of documents may be sent to the server 100 of FIG. 1 and may bypass the attachment checking step 192 of FIG. 5 if the document or documents are known to be of a type other than email attachments.

If a document of interest is determined in step 192 to be an attachment, the document is stripped of its carrier document in step 194 and the carrier document is discarded. If the document is not an attachment, or if the carrier document has been removed in step 194, in step 196 a digital digest, hash code or fingerprint is derived from the full text of the document. The digest value is stored in the RAM 104 of the server computer 100 of FIG. 1. In a preferred embodiment the well known MD5 hashing algorithm is used to derive the digest value. In step 197 of FIG. 5 a copy of the document is made and stored in RAM 104 of FIG. 1 to facilitate document parsing and extraction of substrings.

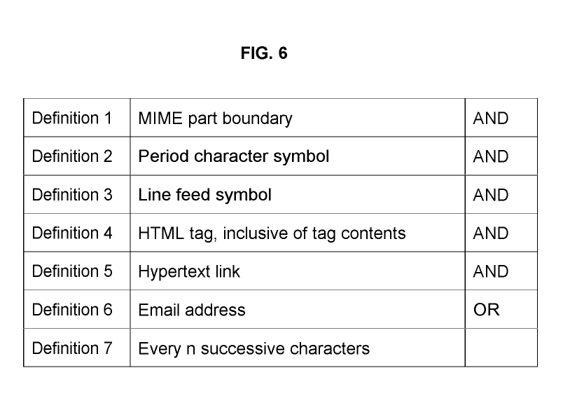

In step 198 of FIG. 5 the full text of the document copy is read by the document collector/parser/storer unit 152 of FIG. 2 until any of a series of one or more possible document parsing boundaries are found as illustrated in FIG. 6, to be explained in greater detail below. When a document parsing boundary is found, control of the process passes to step 200 of FIG. 5, in which the characters preceding the document boundary are extracted and digested, preferably using the MD5 hashing algorithm. It is possible to include the delimiting boundary text as part of the document test substring. In a preferred embodiment the boundary characters are discarded. In step 202 the resulting digest value for the extracted document text substring is stored in the RAM 104 of the server computer 100 of FIG. 1. In step 204 of FIG. 5 the document collector/parser/storer unit 152 then removes the characters comprising the newly extracted substring and its associated boundary point.

In step 206 of FIG. 5 a check is performed to determine whether any characters remain in the document. If more characters exist the process returns to step 198 and continues until all document text subtrings remaining in the document copy have been identified, extracted and digested. Once all the subtrings in the document copy have been processed, in step 208 the document collector/parser/storer stores the following information in the database storage facilities of the server computer 100 of FIG. 1:

a) the full text of the document;

b) the digest of the full text of the document, which serves as a unique identifier of the full text of the document;

c) each pair of extracted document text substrings and their associated digest values, with each digest value serving as a unique identifier of its associated document text substring.

In step 210 of FIG. 5 the document collector/parser/storer unit 152 of FIG. 2 causes a time and date value to be generated and stored as part of the document record to indicate when the document was inserted into the document database 140 of FIG. 2, thereby concluding the process of collecting, parsing and storing a new document. This type of document metadata is stored in the document metadata store 144 of the server computer 100 of FIG. 2.

FIG. 6 illustrates an example of the types of text contained within documents that may be used as boundaries in the document parsing step 198 of FIG. 5. The system operator may choose any type of boundary conditions that suit the needs of the document annotation objective and are not limited to the types of boundaries indicated in FIG. 6. The example shown in FIG. 6 lists six different text features common to email documents that may used, at the option of the system user, to determine the boundary points in a document that define each document text substring. FIG. 6 also lists a seventh boundary definition of an arbitrary nature, explained further below.

Regardless of the document parsing boundary conditions that are set, the result of applying these boundaries in steps 198 and 200 of FIG. 5 is the identification and storage of one or more document text substrings that are contiguous to each other within the original document. This result is true whether a single boundary condition or multiple boundary conditions are defined. FIG. 6 also shows that the first six boundary definitions, for example, may be applied in a logically conjoined way, so that any one of the first six boundary types, if encountered, define a document text substring endpoint.

FIG. 6 further lists a seventh type of document parsing boundary condition in the form of an arbitrary occurrence of a selected number of characters in succession. With this arbitrary non-conjoined boundary condition, each contiguous set of, say, 100 characters within a document would be considered a document text substring. Additionally, this arbitrary method of breaking the original document into substrings has the practical advantage of freeing the document parsing process, if desired, from any reliance upon expected boundary conditions normally characteristic of document types that may not be present within a particular document. I.e., the existence of an alternative or secondary boundary definition that may be invoked if a primary boundary definition or set of definitions fails to find recognizable boundaries ensures that every document will be consistently parsed into document text substrings. If an arbitrary boundary definition is used an additional advantage is obtained, namely that the parsing process is not reliant upon a document structure or expected document structure that a subversive author may attempt to circumvent. An arbitrary rule based on low-level document elements such as a count of successive text characters makes it more difficult for an author of junk email messages, for example, to evade consistent extraction of document substrings from a sample document and from similar documents existent in a network.

Rules for parsing sample documents into consistently definable document text substrings can be applied in the same way described above by other document management systems, such as document search, comparison or filtering systems. If the same parsing rules are applied as employed by the annotation system of the present invention, then unknown or unannotated documents may be compared to sample documents with a greater degree of granularity, on the basis of matching or non-matching substrings. Such finer-grained comparisons advantageously permit detection of partial similarities between unknown documents and sample documents. Whenever one or more document text substrings of an unknown document match those of an annotated sample document, the significance of the partial match can be measured by automatically consulting the annotations associated with each substring of the sample document. If the substrings of the annotated document have been semantically evaluated and annotated by a human annotator in a reliable way then any sample document substrings that are annotated as significant may be used to infer the significance of matching substrings in the unknown or unannotated document.

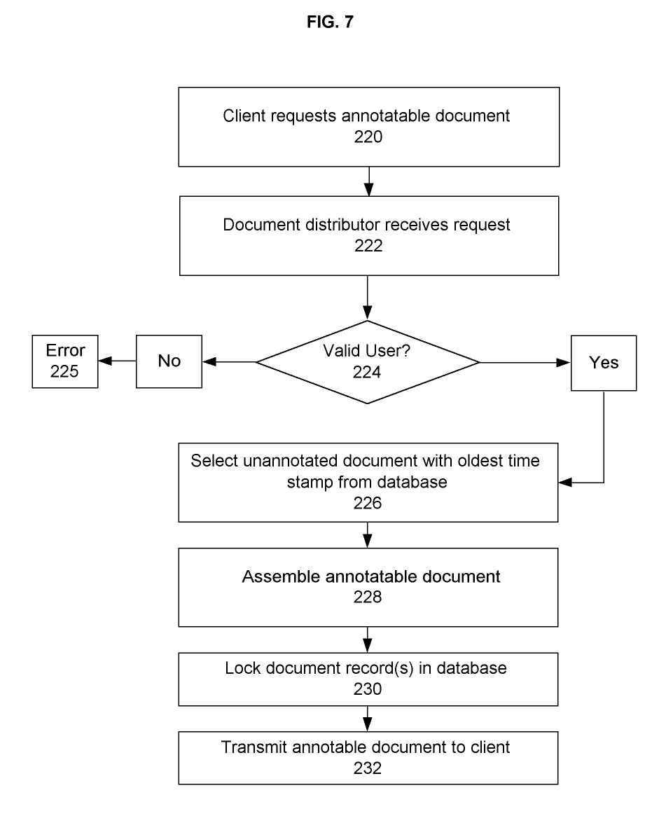

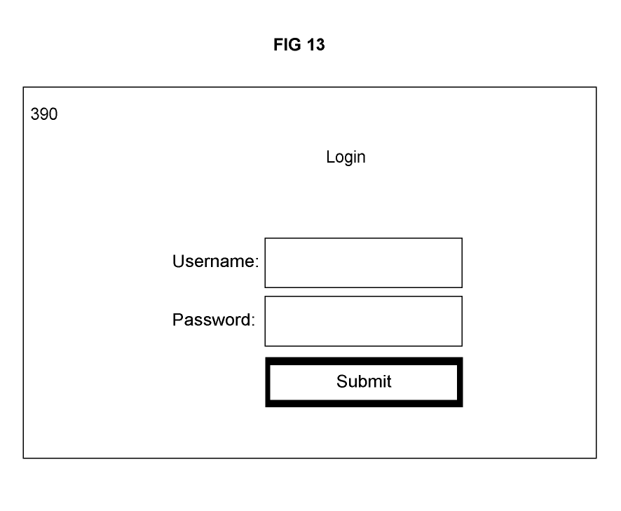

FIG. 7 illustrates a process by which annotatable documents may be distributed from the server computer 100 of FIG. 1 to the client computer 120 of FIG. 1. The process begins with step 220 of FIG. 7, wherein a human annotator activates a control causing the client computer to originate and transmit a request via the network 90 of FIG. 1 to the server computer 100 of FIG. 1 to request delivery of an annotatable document. The document distributor unit 154 of FIG. 2, located on the server computer 100, receives the request for an annotatable document in step 222 of FIG. 7 and passes control of the request to step 224 where the user ID of the requesting client computer is checked for validity. In a preferred embodiment the user ID information is comprised of, at least, a user name and a password which must be manually entered by a human annotator using a login form display. FIG. 13 illustrates an annotator login display, with a login form 390 that exemplifies the user interface for capturing and submitting a user name and password. The login procedure is not required each time a document request is made by an annotator but should be included prior to commencing a document annotation session in order to maintain the trustworthiness of the annotation process.

Continuing with the process illustrated in FIG. 7, if the user ID information submitted is invalid, an error condition 225 occurs and the login attempt is unsuccessful. A login failure message can be passed back to the client computer 120 of FIG. 1 under this circumstance and the human annotator may retry the login procedure. If the user ID information is valid, control passes to step 226 of FIG. 7 where the document distributor 154 of FIG. 1 selects an unannotated document from the document database 140 of FIG. 2. The selection of an unannotated document can be configured by the administrator according to the value of a document time stamp, by a random selection process, or any other order that suits the objectives of the system users. As illustrated in step 228 of FIG 7, in a preferred embodiment, unannotated documents are selected based on the time stamp value indicating the oldest unannotated document in the document database 140.

The final steps of the process illustrated in FIG. 7 include assembling an annotatable document in step 228, locking the database record or records related to the selected annotatable document in step 230 and transmitting an annotatable document in step 232 to the client computer 120 of FIG. 1. An annotatable document includes the full text of a selected document and additional information, as explained next.

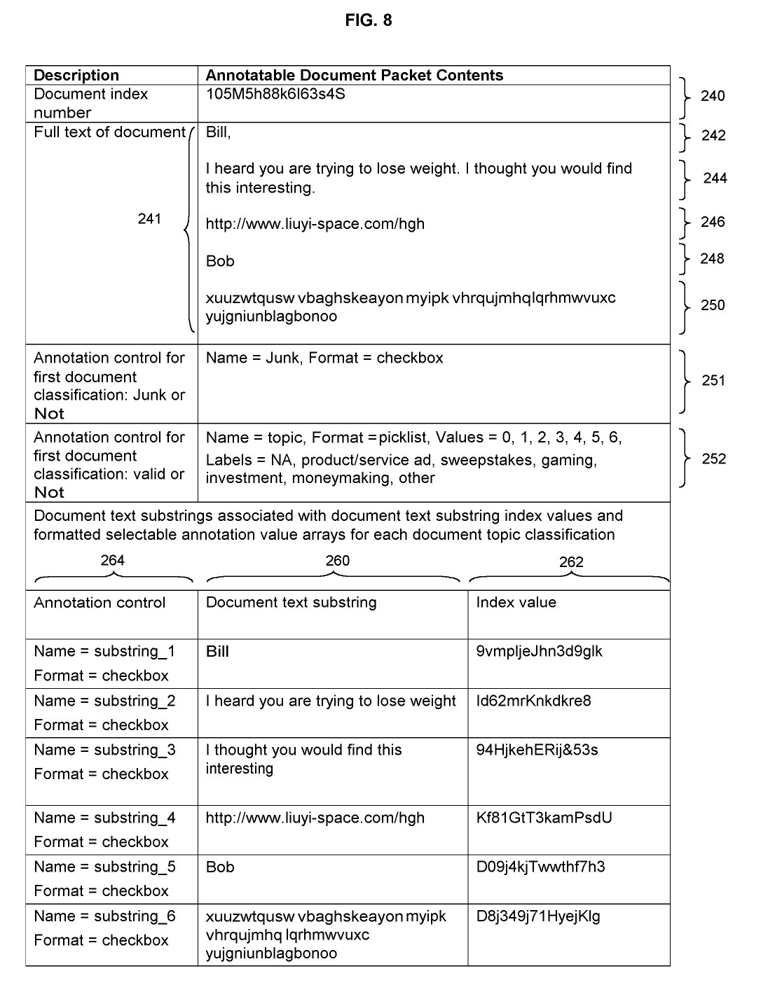

FIG. 8 provides a tabular representation of the information structure of an annotatable document. FIG. 8 also provides within the table a series of sample text components illustrating a possible information structure of an annotatable document. The example includes the following information items:

a) a document index number 240, which, in a preferred embodiment, is derived as an MD5 digest value of the full text of the document in step 196 of FIG. 5;

b) the full text of the document 241;

c) a formatted selectable annotation control featuring an array of selectable values for each document classification to be annotated. In FIG. 8 two such formatted selectable annotation value controls are specified, including one for a first document classification as Junk or Not Junk 251 and a second document classification value control for an array of possible document topic selections 252.

d) a series of document text substrings 260 derived from the full text of the document in steps 198 and 200 in FIG. 5;

e) a series of document text substring index values 262 paired with each document text substring and derived from each document text substring in steps 198 and 200 in FIG. 5, which serve as identifiers for each document text substring 260 in the relational database components 140 and 142 of FIG. 2 that organize documents and document metadata;

f) a formatted selectable annotation value control array 264 paired with each document text substring.

The advantage of including the parsed document text substrings with index values and annotation value arrays for each substring is that substring-level annotations can be supported when the annotatable document is annotated. As seen in FIG. 8 at locations 242 and 248, some of the full text 241 consists of personalizing content that may vary from one version of the document to another. Similarly, at location 250 in FIG. 8 there appears a series of text characters common to junk email messages that consists of nonsense text strings designed to subvert the operation of fingerprint-based email filters. By varying the composition of the text illustrated at location 250 within similar documents, a junk email sender can evade filtering by making each copy of a document different, while each document also contains identical text in every copy as exemplified at locations 244 and 246. The parsed substrings enable these content elements to be separately viewed and annotated during the annotation process. An annotator who is provided with this parsed view of document contents and a method to individually annotate each parsed document text substring may add valuable substring annotations that are useful to automated document filtering systems in discriminating between valid and obfuscating content.

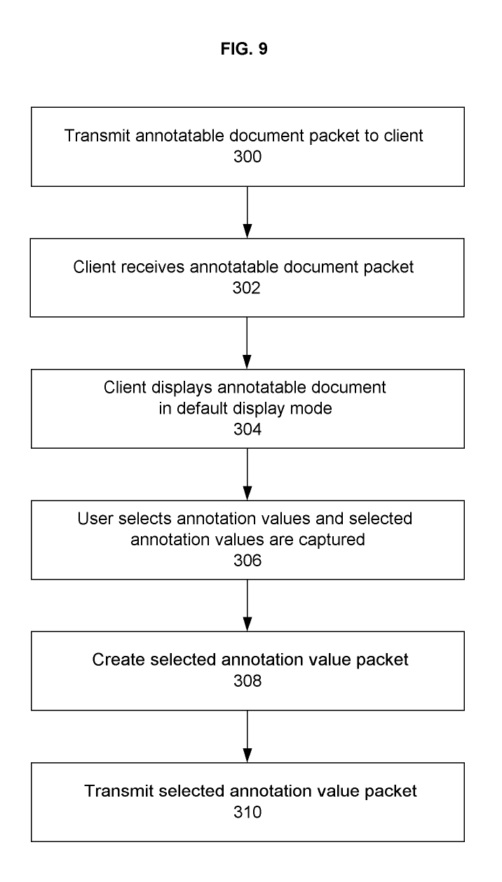

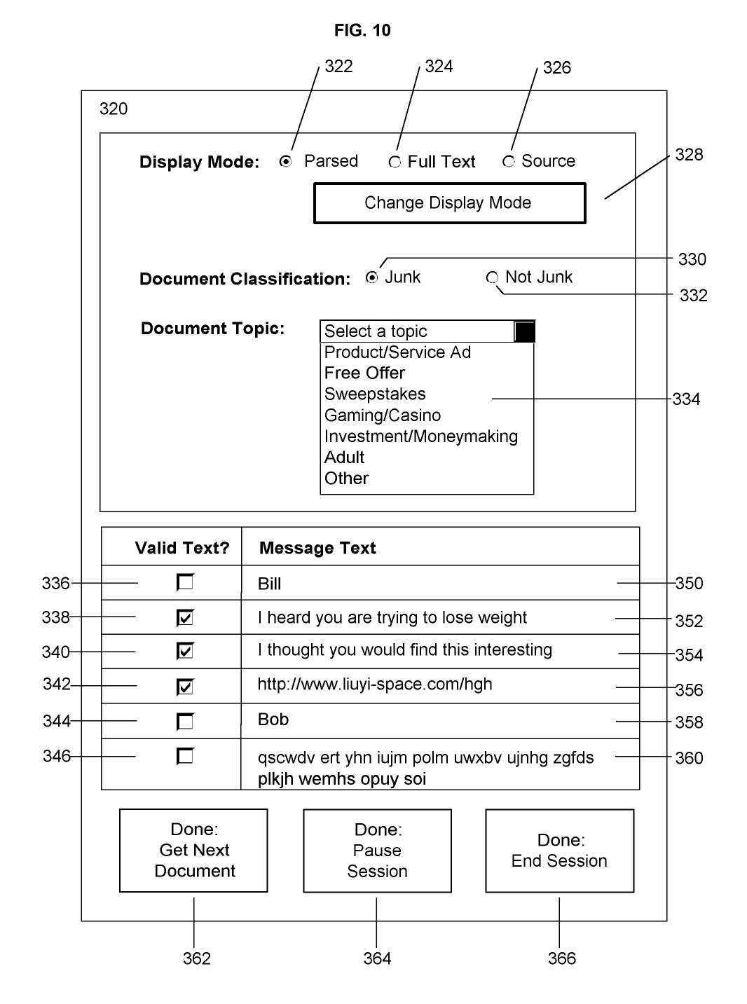

FIG. 9 illustrates a process by which selected annotation values may be captured. The first step in the process 300, responsive to a request from a valid user to receive an annotatable document, is to transmit an annotatable document from the server computer 100 of FIG. 1 to the client computer 120 of FIG. 1. Once received, at step 302 of FIG. 9, the annotatable document is passed to the annotatable document interaction unit 160 of the client computer 120 of FIG. 2A. In a preferred embodiment the annotatable document interaction unit 160 takes the form of a Web browser application program of a type that is widely known and is capable of receiving a document, such as an HTML document, and displaying it in a predetermined graphical user interface format on a display device 130 of FIG. 1, such as a monitor. At step 304 of FIG. 9 the annotatable document is displayed. In a preferred embodiment, there are multiple display modes possible for viewing a document and therefore in step 304 the annotatable form of the document is displayed in a default display mode, such as a parsed display mode as illustrated in FIG. 10.

Returning to FIG. 9, after the annotatable document is displayed in step 304, a human annotator reviews the contents of the annotatable document and decides how to annotate the document. The annotator then selects annotation values from the available set of selectable annotation value choices presented as part of the annotatable document display. In a preferred embodiment the selections of the human annotator are indicated when the annotator interacts with preformatted controls displayed with the annotatable document, by using a pointing device, keyboard or other input device 132 of FIG. 1 to select a control of interest and activating the control to select an annotation value. After interacting with at least one control, the browser application or other form of the annotatable document interaction unit 160 of FIG. 2A automatically records the annotator's interactions at step 306 and passes control to step 308. At step 308 the selected annotation value or values are collected into a packet that associates the selections made by the human annotator with the document and any parts of the document to which the selections should be associated. These associations are made by pairing the selected annotation values with the index values provided in the annotatable document as illustrated in FIG. 8. In step 310 of FIG. 9 the selected annotation value packet is transmitted to the server computer 100 of FIG. 1 via the network 90.

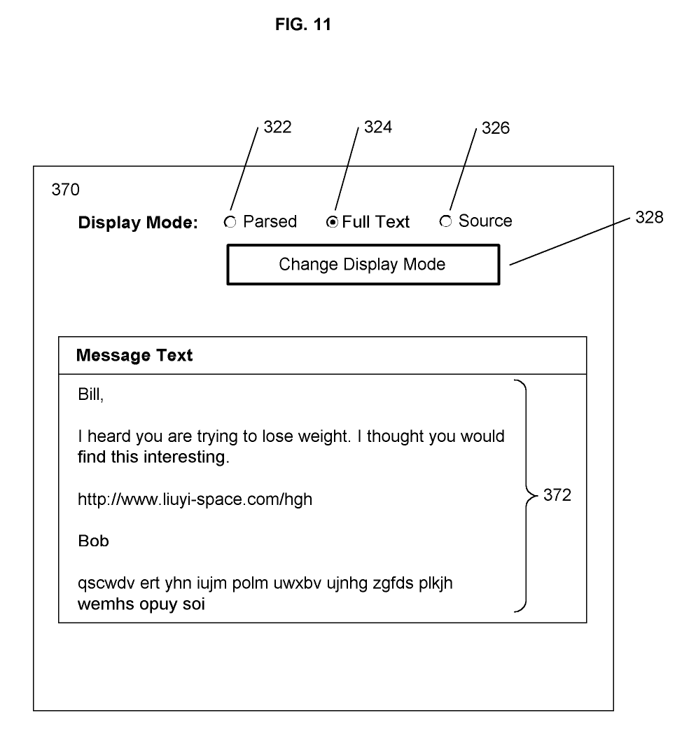

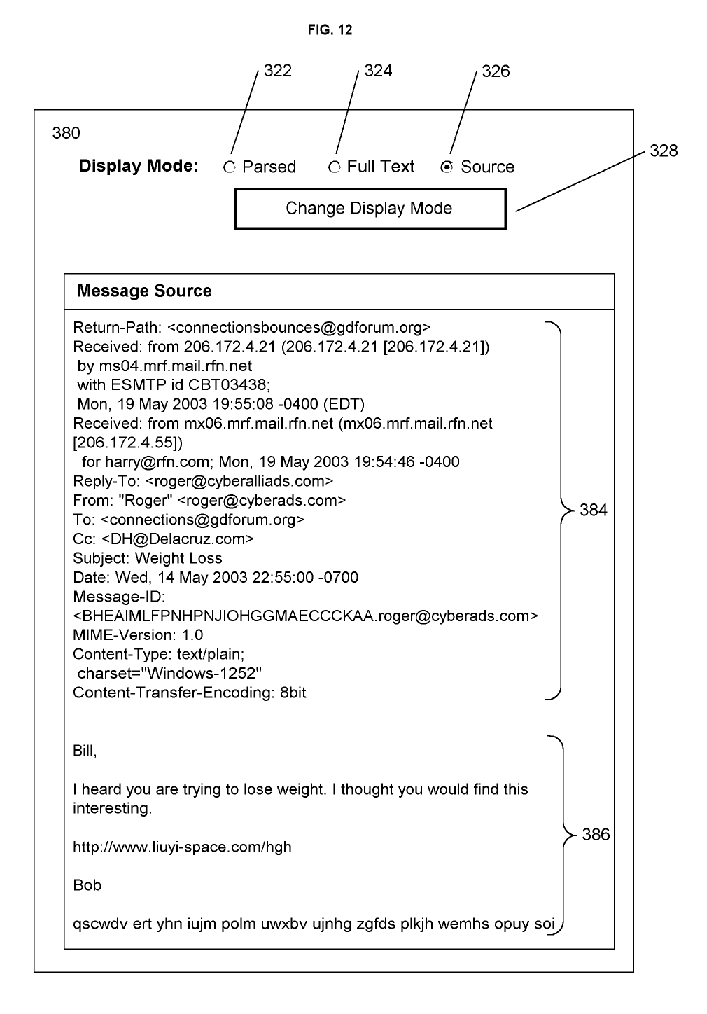

FIG. 10, FIG. 11 and FIG. 12 are schematics of exemplary graphical user interface displays that can be generated on the display device 130 of the client computer 120 of FIG. 1 using the annotatable document interaction unit 160 of FIG. 2A. The example display as illustrated in FIG. 10 can be used by a human annotator to view an annotatable document and its parts, select annotation values from a range of possible values, submit the selected values to the server computer 100 of FIG. 1 and choose whether to request display of another annotatable document, pause the annotation process or terminate the annotation process. It should be noted that the types of annotation definitions and the specific controls as illustrated in FIGS. 10-12 may be modified to suit the needs of the users of the system and the sample annotation definitions and annotation value controls are illustrative only.

Reviewing the features of the graphical user interface display 320 of FIG. 10, which illustrates an annotatable document display in parsed form, a display mode control is provided featuring options to display an annotatable document in parsed 322, full text 324 or source 326 mode. A first button control 328 is used to activate a selected radio button choice among the radio button controls 322-326.

In FIG. 10 the controls 330-346 serve as selectable annotation value input controls that enable the human annotator to express semantic judgments, which are then transmitted when the human annotator also clicks one of the control buttons 362-366. A pair of radio button controls 330 and 332 is provided for selecting a document annotation value of junk or Not Junk. A pick list control 334 enables the annotator to indicate a semantic judgment about the document topic.

In FIG. 10 a series of checkbox controls 336-346 is provided in association with a display of individual document text substrings comprising the full text of the document. The number of checkbox controls is determined by the number of substrings found within the document according to the operation of the assembly of an annotatable document in step 228 of FIG. 7. In FIG. 10, at locations 336, 344 and 346 the checkboxes are illustrated as unchecked, while at locations 338, 340 and 342 the checkboxes are checked. The checked or unchecked status of the checkboxes illustrates the results of human annotator interactions with the checkbox controls to reflect a human semantic judgment about whether each substring should be classified as valid text or not. In this example, substrings at locations 350, 358 and 360 have been classified as invalid and substrings at locations 352, 354 and 356 have been classified as valid.

In order for a human annotator's selections from among the controls labeled 330-346 to be recorded, the human annotator must signify completion of the annotation task by clicking one of the control buttons labeled 362-366. When one of these control buttons 362-366 is clicked the selected annotation values are formed by the annotatable document interaction unit 160 of FIG. 2A into a selected annotation value packet and are then transmitted via the network 90 of FIG. 1 to the server computer 100 of FIG. 1. Activating button control 362 also causes a request for a next annotatable document to be transmitted to the server computer 100 of FIG. 1. Alternatively, the human annotator may activate button control 364 to submit an annotation value packet and pause the annotation session. Alternatively, button control 366 may be selected to submit an annotation value packet and terminate the annotation session.

Display 370 in FIG. 11 illustrates a related display to that shown in FIG. 10. Rather than displaying a document in annotatable form, the display shows the full text 372. No substrings are displayed, and no selectable annotation value controls are displayed. This display option appears in response to selecting the full text radio button control 324 of the default display 320 of FIG. 10 and activating the button control 328 of the default display 320 of FIG. 10. The purpose of the full text display option is to provide a view of a document that is as close as possible to the original view as intended by the document author, rather than a parsed view which may expose normally invisible content and therefore may present a somewhat confusing view of a document. The full text display 370 of FIG. 11 therefore is informational in function and serves to enhance the understanding of a human annotator in judging the content of a document. After viewing display 370 a human annotator, in normal operation, would change the display mode to complete the current annotation task.

Similarly, FIG. 12 illustrates a related informational view of a document rather than presenting a document in annotatable form. In FIG. 12, the display 380 provides a view of a document in a source or source code format, enabling a human annotator to see any details of interest that may be suppressed in other views of the same document, such as formatting information and, in this example, email header information. In FIG. 12 the display mode radio button for source 326 is shown in its selected state. An email message header 384 and an email message body 386 are included in the view of the overall source code form of the message text. After viewing display 380 a human annotator, in normal operation, would change the display mode to complete the current annotation task.

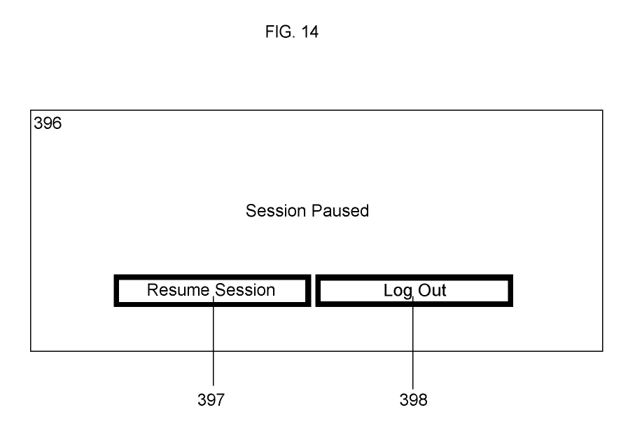

In FIG. 10 the human annotator is provided with a button control 364 causing an annotation session to be paused. Responsive to a human annotator activating button control 364 an instruction is transmitted from the client computer 120 of FIG. 1 to the server computer 100 of FIG. 1. Upon receiving this instruction, the server computer 100 transmits information back to the client computer 120, causing a screen display such as the example illustrated in FIG. 14 to appear on the display device 130 of the client computer 120 of FIG. 1. In FIG. 14 a screen display 396 includes selectable buttons including a first button 397 to resume an annotation session and second button 398 to log out and terminate an annotation session. A human annotator may activate either of these control buttons 397 or 398 to control the resumption or termination of an annotation session.

When an annotation task is completed for an annotatable document, a method is necessary to communicate the data produced by the annotation task from the client computer 100 of FIG. 1 to the server computer 100 of FIG. 1 FIG. An annotation value packet is formed by the annotatable document interaction unit 160 of FIG. 2A when an annotator completes the process of selecting annotation values and activates a control such as button 362 of FIG. 10, corresponding with step 306 of FIG. 9. At step 308 of FIG. 9 an annotation value packet is created by the browser application or any other form of an annotatable document interaction unit 160 of the client computer 120 of FIG. 2A. In a preferred embodiment, an HTML document of a form illustrated by the screen display 320 of FIG. 10 includes programming code that instructs the browser application to collect the selected annotation values inputted by the human annotator, associate them with index values provided in relation to each selectable annotation value array, and construct an http packet that includes all the information necessary to convey to the server computer 100 of FIG. 1 how a document should be annotated.

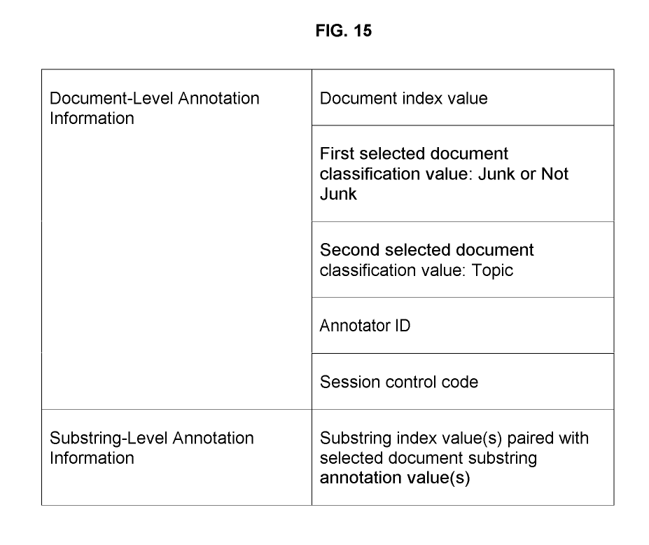

FIG. 15 illustrates a sample list of annotation information that may comprise an annotation value packet. The packet includes a document index value that uniquely identifies the document relative to all others in the document storage unit 140 of FIG. 2. The packet illustrated in FIG. 15 includes selected annotation values associated with the document, such as a first selected document classification value of junk or Not Junk and a second selected document classification value representing a document topic. Each of these two selected annotation values is associated with the document using the document index value. Additionally a document annotator ID is included in the packet to enable identification of a human annotator that performed the annotation task. A session control code is included in the packet in order to instruct the server computer 100 of FIG. 1 whether to distribute another annotatable document to the client computer 120 of FIG. 1. The session control code has a value determined by which button the human annotator activates from among the group of buttons 362-366 in FIG. 10

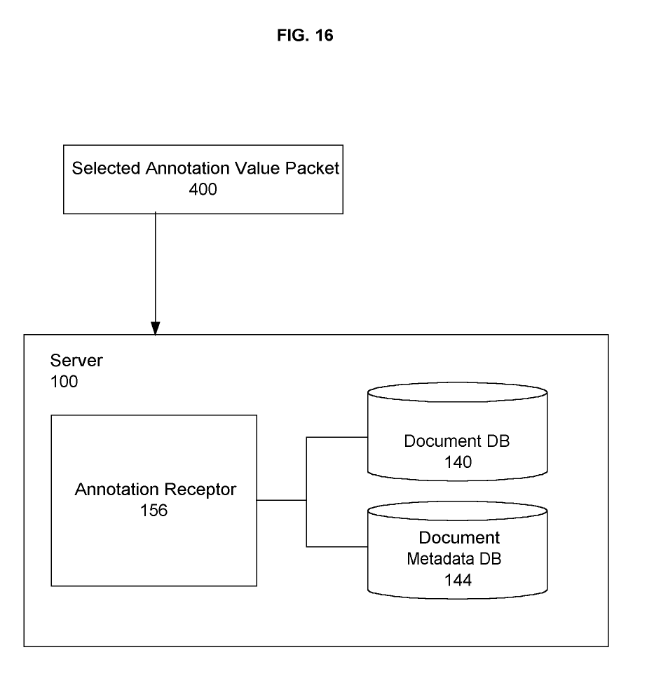

Finally, and at the option of the system users, more detailed annotations may be included in the annotation value packet, in the form of document text substring annotation values. In FIG. 15 only one type of document text substring annotation value is listed, but it is possible to include more than one type of document text substring annotation value for each document text substring. Each document text substring annotation value is associated with a particular document text substring using the index value that is generated for each document text substring at steps 198 and 200 of FIG. 5. When a selected annotation value packet is formed and transmitted to the server computer 100 of FIG. 16, the annotation receptor unit 156 parses the information in the packet, extracts the annotation value packet contents, and inserts the values in the appropriate record and data fields in the document database 140 and the document metadata database 144.

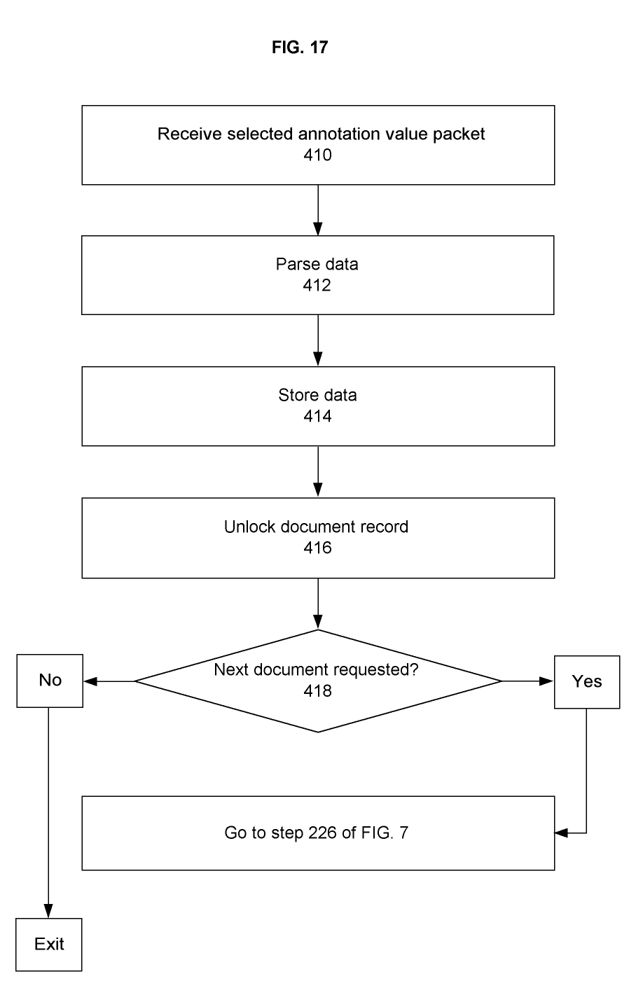

FIG. 17 illustrates a more detailed view of the process of managing a selected annotation value packet. A packet is received by the server computer 100 of FIG. 16 at step 410 of FIG. 17, where the data within the packet is parsed 412 and stored 414. The document record, which had been locked previously to prevent concurrent usage of a record in the process of being modified, is unlocked 416. The packet contains a session control code indicating whether a next annotatable document has been requested. At step 418 this code is evaluated to determine whether or not to distribute a next annotatable document to the client computer 120 of FIG. 1. If there is no such request the process terminates, otherwise control is passed to step 226 of FIG. 7 whereby another document will be selected.

To summarize the types of information used by the invention, according to a preferred embodiment of the invention the following data fields should be created in a relational database:

Annotation definition database fields:

a) Document annotation type

b) Document annotation format

c) Selectable document annotation values

d) Selectable document annotation value labels

Document information database fields:

e) Document index value

f) Document full text

Document metadata database fields:

g) Document record creation time and date

h) Document text substring

i) Document text substring index value

j) Annotation time and date

k) Annotator ID

l) Selected document text annotation values

In a preferred embodiment of the invention a series of related database tables are used to store the different types of information efficiently, as will be understood by those familiar with the prior art.

Removing Duplicated or Nearly Duplicated Sample Documents

In the event that duplicate or near duplicate documents are submitted for annotation it is desirable to have a method by which these documents may be discarded if their differences from previously annotated documents are trivial. In one embodiment an automated duplicate removal technique may be employed by attaching a filtering apparatus and program to the document collector/parser/storer that could detect similarities between each newly received document and all currently stored documents. Such a system potentially would reduce redundant annotation effort and, in turn, would benefit by utilizing the additive information provided by the annotation process.

In another embodiment, a less complex method to remove duplicates is to provide a program that enables an administrator or a human annotator to input one or more search terms and, responsive to a command or program instruction, discards any document upon its receipt if the document matches the search term. The search term may be comprised of a single string of text or other logical expression of document content, including multiple conditions that may be combined, such as by a Boolean query.

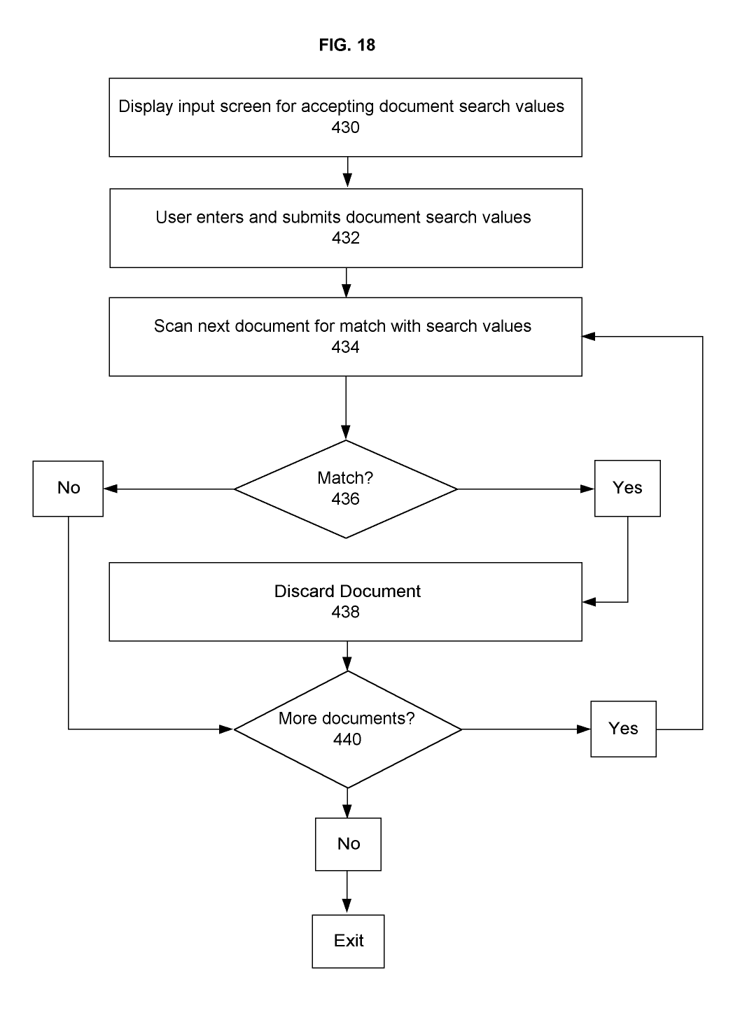

FIG. 18 illustrates a process that may be used, in a preferred embodiment of the invention, to screen out duplicate or near duplicate documents that are not useful to the annotation results. The duplicate document removal process illustrated in FIG. 18 begins at step 430, in which a user is presented with a display screen for accepting document search values. A user enters and submits document search values in step 432. In step 434 a document deduplicator unit 158 located at the server computer 100 of FIG. 2 receives the search term and executes a scan of one or more documents that have not yet been annotated and that may include duplicate or near duplicate documents. In a preferred embodiment these documents may be stored in the document storage unit 140 of FIG. 1 but they also may be stored in a file system or other storage facility that is separate from the document storage unit 140. In any case it should be possible to search a set of unannotated documents on demand at step 434 by way of a search term and command that is manually entered at step 432. At step 436 a candidate document is evaluated as to whether a match exists between a search term and the contents of the document. If a match is found the matching document is discarded at step 438 and control of the process passes to step 440. If there is no match at step 436 control passes to step 440, where a check for the existence of additional candidate documents is performed. If there is an additional document to scan, control passes back to step 434. If there are no additional documents to check for a match, the process terminates.

In an alternative embodiment of the process illustrated in FIG. 18 it is possible to establish an automatic duplicate checking routine that stores one or more search terms and checks newly submitted documents for matches according to any of a set of search terms. Further, it is possible to configure this alternative duplicate checking routine to check each document as it is submitted or to check documents that accumulate in batches of two or more potentially duplicate documents.

Conclusions, Ramifications and Scope

Accordingly, the reader will see that the annotation system of the present invention provides a method for efficiently capturing human judgments about the semantic content of documents and for storing these judgments in a structured form. An important ramification of this ability is that other document management systems may use the annotated sample documents to more accurately find, classify or filter other documents, including unknown or unclassified documents. A service provider can provide automated document management systems with access to the annotated sample document information. Such a separate system, such as a document indexing, search, comparison or filtering system, can use the annotated sample documents to make more accurate automated judgments about other and unknown documents than is possible without the aid of the semantically accurate annotations.

The annotation system enables recording of annotations related to documents as a whole and to portions of documents. An important ramification of this ability is that inferences about compared documents may be made when compared documents exactly match each other and also when only one or more portions match. When exact matches between unknown documents and sample documents are found, a reliable inference about the classification of the unknown document may be made from the classification assigned by a human annotator to a matching annotated sample document. When partial similarities are found between an unknown documents and an annotated sample document, a reliable inference about the unknown document may be made based upon whether the similarities are found among sample document portions considered by a human annotator to be valid and significant, as opposed to invalid, trivial or obfuscating content.

The method used by the annotation system for selecting document portions or substrings must be applied consistently to both sample documents and to unknown documents that are the objects of comparison in order for these inferences to be valid. Further, annotation data must be structured and captured in a logical, consistent and disciplined manner as described above. Human annotators must be instructed to apply careful and consistent reasoning in the selection of annotation values that they associate with sample document contents. If these methods are rigorously applied as described, the annotation system can overcome attempts by document authors to subvert document similarity detection whenever authors employ document obfuscation tactics.

The annotation system helps to spare end users of document management systems from a burden of document classification. Using the invention, as few as one document annotator operating in the mode of a service provider can annotate sample documents so that another document management system can apply the annotation information and sample documents to automatically performing more accurate document management functions. The invention thereby beneficially shifts the burden of teaching an automated system to recognize patterns from a group of end users to a centralized service provider.

The annotation system does not require multiple occurrences or sightings by the system or by document annotators of the same or substantially similar document to enable a classification decision. A trained document annotator may judge the contents of a document and semantically label its contents by applying human reasoning and, as needed, by referring to a document annotation policy, thereby saving time and effort.

Although the description above contains many specificities, these should not be construed as limiting the scope of the invention but as merely providing illustrations of some of the presently preferred embodiments of this invention. Many other variations are possible. For example, the sample documents to be annotated may be displayed and reviewed in a paired fashion so that two documents that are found through automated methods to contain similar substrings may be presented in a side-by-side screen display. This alternative method of implementation would, by way of illustration, provide a different and additive way for a human annotator to judge whether certain substrings are valid or appear to be of a personalizing or obfuscating nature.

Accordingly, the scope of the invention should be determined not by the embodiments illustrated, but by the appended claims and their legal equivalents.

1. A computer-controlled method of managing manual annotation of electronic documents, whereby unknown electronic documents may be more accurately identified via automatic comparisons to document patterns derived from manually annotated electronic documents, comprising a first storage means for storing at least one of a plurality of documents; a second storage means for storing at least one of a plurality of document annotation definitions; a third storage means for storing at least one of a plurality of selected document annotation values and at least one of a plurality of document index values identifying one of a plurality of said documents or portions thereof to which said selected document annotation values relate; and a document annotation value capture means:

2. The method of claim 1 wherein each one of said plurality of document annotation definitions includes a document annotation type, a document annotation data format, at least two of a predetermined plurality of selectable document annotation values associated with said document annotation type and format and at least two of a plurality of annotation value labels associated with each of said selectable document annotation values.

3. The method of claim 1 comprising a means of capturing and storing at least one of said plurality of selected document annotation values and at least one of said document index values in relation to at least one of a plurality of document text substrings.

4. The method of claim 1 comprising a means of capturing and storing at least one of said plurality of selected document annotation values and at least one of said document index values for each of said plurality of document text substrings comprising one of a plurality of said electronic documents.

5. The method of claim 1 comprising a means by which said plurality of document text substrings are automatically selected prior to document annotation value capture according to a predetermined set of rules for defining consistently identifiable document text substring types.

6. The method of claim 5 wherein said rules for defining consistently identifiable document text substring types include partitioning document text into character groupings that may be selected at arbitrary locations within said document irrespective of the native or inherent text content divisions or indexing schema of said document.

7. A computer-controlled method of managing manual annotation of electronic documents, whereby unknown electronic documents may be more accurately identified via automatic comparisons to document patterns derived from manually annotated electronic documents, comprising the steps of:
(a) Providing a computer network means of data communications between at least one of a plurality of client computers each serving as a document annotation workstation and at least one of a plurality of server computers;
(b) Providing on said server computer:
i. a first storage means for storing at least one of a plurality of documents;
ii. a second storage means for storing at least one of a plurality of document annotation definitions; and
iii. a third storage means for storing at least one of a plurality of selected document annotation values and at least one of a plurality of document index values identifying one of a plurality of said documents or portions thereof to which said selected document annotation values relate;
(c) Providing for each of said document annotation workstations:
i. a display means for a simultaneous user interface screen display of at least one of a plurality of documents and at least one of a set of selectable document annotation value interactive input controls; and
ii. an input means enabling a human annotator to perform interactive entry of information and commands into said document annotation workstation;
(d) Providing on said server computer a document information distribution means configured to transmit to at least one of said plurality of document annotation workstations on demand a copy of an annotatable document including said full text of said document and including at least two of said plurality of selectable document annotation values and labels associated with said selectable document annotation values and including at least one of said plurality of document index values associated with said selectable document annotation values;
(e) Providing on said server computer an annotation reception means configured to receive and store at least one of a plurality of selected document annotation values and at least one of said plurality of document index values transmitted from at least one of said plurality of document annotation workstations;
(f) Responsive to an electronic document retrieval request, said request originated by one of a plurality of human annotators located at one of a plurality of said document annotation workstations, automatically selecting at least one of a plurality of documents stored at said server computer and transmitting to said document annotation workstation an annotatable document;
(g) Receiving and simultaneously displaying at said document annotation workstation a user interface screen display of said copy of said annotatable document and at least one of a plurality of interactive controls configured to accept input commands responsive to said human annotator's selection of at least one of said selectable document annotation values;
(h) Providing at said document annotation workstation a screen display of an interactive control and an automated means causing, responsive to input of said human annotator, transmission to said server computer at least one of a plurality of said selected document annotation values selected by said human annotator;
(i) Responsive to receipt of said selected document annotation values from said document annotation workstation, automatically receiving and storing at said server computer said selected document annotation values and said document index values, whereby said selectable document annotation values are bound via said document index values to said document or to one of a plurality of said document text substrings.

8. The method of claim 7(b) comprising the step of accepting and storing copies of said plurality of documents from any desired source, including manual or automated forwarding of document copies from human operators or via automated document relaying systems.

9. The method of claim 7(b) comprising the step of implementing said storage means as a database, such as a relational database, configured to store said plurality of documents and other document information in a logical structure, including unique data rows or data records designated for each of said plurality of documents, and a plurality of unique data columns or data fields designated for storage of each unique type of document information.

10. The method of claim 9 comprising the step of providing data fields for storing said document information including:
(a) a data field for storing said full text of one each of said plurality of documents;
(b) a data field for storing a data record label serving as a unique document identifier;
(c) a data field for storing a value indicating the time and date when said document was inserted into said database;
(d) a plurality of data fields for storing extracts or digests of said document contents;
(e) a data field for storing a value indicating said time and date when said document has undergone an annotation procedure;
(f) a data field for storing a value indicating the identities of said plurality of human annotators who have performed annotation procedures;
(g) a plurality of data fields for storing a plurality of said selected document annotation values and said plurality of document index values.

11. The method of claim 10 wherein a plurality of said data fields are automatically populated with data whenever said plurality of document data records are created, including a plurality of data fields for:
(a) said data field for storing said full text of one each of said plurality of documents;
(b) said data field for storing a unique data record label;
(c) said data field for storing a value indicating said time and date when said document was inserted into said database;
(d) said plurality of data fields for storing extracts or digests of said document contents.

12. The method of claim 10 wherein some of said data fields are automatically populated with data when a human annotation procedure for a particular document is completed, including:
(a) said data field for storing a value indicating said time and date when said document has undergone an annotation procedure;
(b) said data field for storing a value indicating said identities of said plurality of human annotators who have performed said annotation procedures;
(c) said plurality of data fields for storing a plurality of selected document annotation values and plurality of document index values.

13. The method of claim 7f wherein said annotatable document includes said unique identifier for said selected document, said full text of said selected document, a parsed set of document text substrings derived from said document, said document text substring index values derived from said parsed set of document text substrings, and at least one of a plurality of selectable annotation values associated with said document.

14. The method of claim 7f comprising the step of originating said electronic document retrieval request by one of a plurality of means, including:
(a) an unauthenticated human annotator entering valid personal authentication information into an interactive user interface screen display of an authentication information form and activating a login control displayed on said display screen causing transmission of a code to said server computer triggering an authentication process and, if said authentication information is determined to be valid by said server computer, signifying said human annotator's readiness to commence an annotation procedure;
(b) a previously authenticated and logged in human annotator activating an annotation session resumption control displayed on said display screen causing transmission of a code to said server computer signifying said human annotators readiness to resume a previously paused annotation procedure;
(c) a previously authenticated and logged in human annotator activating an annotation procedure completion control displayed on said display screen causing transmission of a code to said server computer signifying said human annotators completion of a first annotation procedure and readiness to commence a second annotation procedure.

15. The method of claim 7f further comprising the step of selecting only unannotated documents for transmission to one of said plurality of document annotation workstations according values stored in said database field indicating said times and dates when said plurality of documents have undergone annotation procedures, whereby said previously annotated documents may be prevented from undergoing additional and redundant annotation procedures.

16. The method of claim 7f further comprising the step of applying a predetermined and configurable rule to determine the order in which said unannotated documents are selected and transmitted to said human annotator workstation, wherein said rule may include any of the following:
(a) selecting and transmitting a next document according to said value stored in said data field indicating said time and date when said document was stored in said database;
(b) selecting and transmitting a next document according to a random selection process;
whereby said order in which one of said plurality of documents selected for said document annotation procedure may be selected in a priority order reflecting the priorities of the system operator and its users.

17. The method of claim 7(f) further comprising the step of locking each of said data records in said database for the duration of a human annotation procedure, whereby distribution of said plurality of documents from said server computer among a plurality of said human annotator workstations may be controlled and redundant concurrent reviews of said plurality of documents may be avoided.

18. The method of claim 7(f) further comprising the step of automatically identifying and discarding at least one of a plurality of duplicate and near duplicate documents prior to selecting one of said plurality of documents to be transmitted to one of said plurality of document annotation workstations, whereby redundant human annotation effort can be partially or entirely avoided and the costs of employing human annotators to annotate said documents may be minimized.

19. The method of claim 18 further comprising the step of identifying and discarding at least one of said duplicate or near duplicate documents in response to manual input of at least one of a plurality of selected search conditions.

20. The method of claim 7g further comprising the step of providing a user interface screen display control enabling said human annotator to select at least one of a plurality of display modes of said document, said display modes including:
(a) a normal or full text display mode that is consistent with how said document would be displayed or rendered in everyday use;
(b) a parsed display mode that presents each of said document text substrings comprising said document as distinct and sequential text groupings, such as a tabular array in which said document text substrings are presented in a vertical column, with one each of a plurality of said document text substrings contained in each of a plurality of table rows, said document text substrings ordered sequentially from top to bottom in the order in which said document text substrings appear in said document; and
(c) a source code display mode that displays said document in a form that includes the raw character stream composing said document including characters visible in said normal display mode and including characters comprising said document that include document metadata and document structure and formatting data;
whereby said human annotator may easily alter the manner in which said document is displayed to enable a fuller understanding of said document's content and structure as needed to make an accurate annotation selection.

21. The method of claim 7g further comprising the step of providing a user interface screen display of controls associated with said annotatable document; said controls including at least one of the following plurality of controls:
(a) a selectable control enabling said human annotator to indicate whether said document as a whole either meets or does not meet a specified document classification; and
(b) a selectable control enabling said human annotator to indicate one of a range of possible document topic judgments;
whereby said human annotator may select at least one of said plurality of selectable document annotation values describing said human annotators semantic judgment regarding said document's content.

22. The method of claim 7(g) further comprising the step of providing, when said document is displayed in parsed mode, a screen display of at least one of a plurality of interactive input controls associated with each of at least one of a corresponding plurality of document text substrings, such that each of said interactive input controls are displayed in positions clearly associated with said corresponding document text substrings, such as displayed directly alongside each document text substring within one of a plurality of said table rows occupied by said document text substring.

23. The method of claim 7(g) further comprising the step of displaying, in a split user interface screen display, two or more of said plurality of documents that have been determined by an automated process as possibly similar documents, whereby said human annotator may more easily determine whether said plurality of documents are semantically equivalent or not, and whereby said human annotators ability to make a correct judgment concerning how to label potential personalization or obfuscation text may be enhanced by considering the content of more than one document at the same time.

24. The method of claim 7 wherein said documents are:
(a) email messages compatible with conventional email systems, wireless messaging systems or instant messaging systems;
(b) HTML documents.
